(19) United States
(12) Patent Application Publication
(10) Pub. No.: US 2026/0319322 A1
(43) Pub. Date: Oct. 15, 2026

(54) OPTICAL INTERFEROMETER

(71) Applicants: NTT, Inc., Tokyo (JP); The University of Tokyo, Bunkyo-ku, Tokyo (JP)

(72) Inventors: Shiori Konisho, Musashino-shi, Tokyo (JP); Junji Sakamoto, Musashino-shi, Tokyo (JP); Hiromitsu Imai, Musashino-shi, Tokyo (JP); Tomoya Akatsuka, Musashino-shi, Tokyo (JP); Toshikazu Hashimoto, Musashino-shi, Tokyo (JP); Katsuya Oguri, Musashino-shi, Tokyo (JP); Atsushi Ishizawa, Musashino-shi, Tokyo (JP); Hideki Goto, Musashino-shi, Tokyo (JP); Tetsuomi Sogawa, Musashino-shi, Tokyo (JP); Hidetoshi Katori, Bunkyo-ku, Tokyo (JP)

(21) Appl. No.: 19/117,334

(22) PCT Filed: Oct. 6, 2023
(86) PCT No.: PCT/JP2023/036614

§ 371 Date: Mar. 31, 2025

(30) Foreign Application Priority Data
Oct. 6, 2022 (JP) 2022-161829

(51) Int. Cl. G02F 1/225; G04F 5/14

(52) U.S. Cl. CPC G02F 1/225; G04F 5/14

(57) ABSTRACT

An optical interferometer according to the present disclosure is an optical interferometer formed by using a waveguide on a substrate, including a first coupler that branches light inputted from a reproduced standard light input port into A+1 (A≥1); a partial reflection circuit that reflects part of light inputted from a reference light input/output port and transmits part of the light, one frequency synchronization detection circuit that generates first interference light that the transmitted light from the partial reflection circuit and part of reproduced standard light branched by the first coupler interfere with each other, and A transmission path length fluctuation detection circuits that generate second interference light that part of the reproduced standard light outputted from another port of the first coupler and light inputted from a transmission path fiber input/output port interfere with each other.

### TECHNICAL FIELD

The present disclosure relates to an optical interferometer, and more specifically relates to an optical interferometer to be applied to a transmission system of frequency standard light using an optical fiber.

### BACKGROUND ART

As a novel time frequency standard (frequency standard), the optical clock technology using light have been developed. Conventionally, atomic clocks using the microwave transition of cesium ¹³³Cs (about 9.2 GHZ) have been used as a frequency standard, and the uncertainty has been around 10⁻¹⁵. In contrast, optical lattice clocks (optical clocks) using the optical frequency transition (about 429 THz) of strontium ⁸⁷Sr, which have been increasingly studied in recent years, have achieved to an uncertainty of 10⁻¹⁸ (see, for example, NPLs 1 and 2). This is because the transition frequency fluctuation determined by the quantum limit basically does not depend on a frequency, and the uncertainty, which is a ratio between the transition frequency fluctuation and the transition frequency, is fundamentally advantageous with the higher frequency used.

As a technology for transmitting frequency standard light having a quite highly-accurate frequency which is obtained by an optical clock while maintaining the frequency accuracy, there is a highly-accurate frequency transmission technology using an optical fiber (see, for example, NPLs 3 and 4). An optical fiber has a stably small propagation loss, and is most appropriate as a medium for transmitting an optical signal. However, since a physical medium generally has a photoelastic effect and a thermooptical effect, effective optical length slightly varies depending on vibration and temperature change. This variation in length causes the Doppler effect in the propagated light, and thus causes frequency fluctuation in propagated light. Hence, a mechanism for effectively correcting this variation in length is required for a transmission system in order to transmit frequency standard light while maintaining the frequency accuracy.

FIG. 1 is a diagram conceptually showing a configuration of a transmission system 10 using the highly-accurate frequency transmission technology according to the conventional technology. Note that the arrows in the drawing indicate propagation directions of light. As shown in FIG. 1, the transmission system 10 includes a transmitting station 11 which sends frequency standard light, a receiving station 13 which receives the frequency standard light and sends reproduced standard light, and a repeater station 12 which is disposed between the transmitting station 11 and the receiving station 13, in which the transmitting station 11 and the repeater station 12, and the repeater station 12 and the receiving station 13, are connected by transmission path fibers 14a, b, respectively. Inputs of the transmission path fibers 14a, b are connected to outputs of fiber length fluctuation compensation units 15a, b which are disposed in the transmitting station 11 and the repeater station 12, respectively. On the other hand, outputs of the transmission path fibers 14a, b are connected to inputs of polarization controllers 17a, b which are disposed in the repeater station 12 and the receiving station 13, and outputs of the polarization controllers 17a, b are connected to inputs of standard light reproducing units 16a, b, and an output of the standard light reproducing unit 16a is connected to an input of the fiber length fluctuation compensation unit 15b. Note that although FIG. 1 is shown such that one repeater station 12 is disposed, the number of the repeater stations 12 disposed is not limited to one, and a plurality of the repeater stations 12 can be disposed depending on the distance between the transmitting station 11 and the receiving station 13, and the like.

The fiber length fluctuation compensation unit 15a, b has a function of compensating for frequency/phase fluctuation which the frequency standard light has received during transmission, and is a space optical system similar to the Michelson interferometer. As systems for compensating for frequency/phase fluctuation which the frequency standard light has received, two systems, that is, a system which detects interference light of beams of frequency standard light (see, for example, NPL 5) and a system which detects interference light of frequency standard light and reproduced standard light (see, for example, NPL 6) have been proposed. In the present description, the former is referred to as a “system 1”, and the latter is referred to as a “system 2”.

FIG. 2 is diagrams conceptually showing structures from the fiber length fluctuation compensation unit 15a, b to the polarization controller 17a, b in the conventional technology, and (a) and (b) show a case of the system 1 and a case of the system 2, respectively. As shown in FIG. 2, the fiber length fluctuation compensation unit 15a, b includes a half mirror 151, a mirror 152, a photodetector 153, a clock source 154, a phase synchronization controller 155, a voltage-controlled oscillator 156, and an acousto-optic modulator 157. In the case of the system 1 as shown in FIG. 2(a), a partial reflection mirror 21 is additionally disposed between the polarization controller 17a, b, which is a transmission destination, and the standard light reproducing unit 16a, b. Note that in the case where the transmission path fiber 14a, b is a polarization-maintaining fiber, it is also possible to omit the polarization controller 17a, b.

In the system 1, interference light of two beams of light, that is, frequency standard light which has not received frequency/phase fluctuation and frequency standard light which has received frequency/phase fluctuation while reciprocating the transmission path fiber 14a, b, is detected by the photodetector 153. Part of the frequency standard light inputted into the fiber length fluctuation compensation unit 15a, b is reflected by the half mirror 151, is then totally reflected by the mirror 152, is transmitted through the half mirror 151, and is guided to the photodetector 153. This frequency standard light becomes reference light which has not received frequency/phase fluctuation in the transmission path fiber (for example, the transmission path fiber 14a, b). On the other hand, part of the frequency standard light is transmitted through the half mirror 151, is guided through the transmission path fiber 14a, b, is reflected by the partial reflection mirror 21, again propagates the transmission path fiber 14a, b, is reflected by the half mirror 151, and is guided to the photodetector 153. This frequency standard light is reference-target light which has received frequency/phase fluctuation while propagating the transmission path fiber 14a, b, and has received frequency shift by the acousto-optic modulator 157. Interference light of this reference light and reference-target light is detected by the photodetector 153, and a detection signal thus obtained and a frequency signal generated by the clock source 154 are inputted into the phase synchronization controller 155, and a signal for compensating for the frequency/phase fluctuation is generated through the voltage-controlled oscillator 156, and is inputted into the acousto-optic modulator 157. This causes the frequency accuracy of the frequency standard light to match in the half mirror 151 and the partial reflection mirror 21 to compensate for the frequency/phase fluctuation. The frequency standard light in which the frequency/phase fluctuation has been compensated for is transmitted through the partial reflection mirror 21, and is transmitted to the next station.

On the other hand, in the system 2, interference light of frequency standard light and reproduced standard light which has been transmitted through a transmission path fiber and has received frequency/phase fluctuation is detected by a photodetector. The frequency standard light, which is reference light, is reflected by the half mirror 151, then is totally reflected by the mirror 152, is transmitted through the half mirror 151, and is guided to the photodetector 153, like the system 1. On the other hand, the reproduced standard light, which is reference-target light, is inputted from a standard light reproducing unit 16a, b (not shown), which is disposed in a transmission destination, and is guided to the photodetector 153, via a transmission path fiber 14a, b. Then, interference light of this reference light and reference-target light is detected by the photodetector 153, a detection signal thus obtained and a frequency signal generated in the clock source 154 are inputted into the phase synchronization controller 155, a signal for compensating for frequency/phase fluctuation is generated through the voltage-controlled oscillator 156, and is inputted into the acousto-optic modulator 157. As a result, by compensating for the frequency/phase fluctuation received in the transmission path fiber 14a, b, the frequency accuracy of the frequency standard light is caused to coincide in the half mirror 151 and at a position at which the reproduced standard light is outputted (the standard light reproducing unit 16a, b).

In the standard light reproducing unit 16a, b, reproduced standard light having the same frequency accuracy is generated from the transmitted frequency standard light. FIG. 3 is a diagram conceptually showing structures of a standard light reproducing units 16a, b according to the conventional technology, and (a) and (b) show a case of the system 1 and a case of the system 2, respectively. As shown in FIG. 3(a), the standard light reproducing unit 16a, b in the system 1 includes a standard light reproduction light source 161 which sends reproduced standard light serving as reference-target light, a photodetector 162 which detects interference light of reference light and the reference-target light, a clock source 163, a phase synchronization controller 164, and half mirrors 165, 166. In the system 1, frequency standard light (reference light) transmitted from the fiber length fluctuation compensation unit 15a, b is transmitted through the half mirror 166, and is guided to the photodetector 162. On the other hand, reproduced standard light, which is reference-target light, is generated from the standard light reproduction light source, is reflected by the half mirror 166, and is guided to the photodetector 162. Interference light of this reference light and reference-target light is detected by the photodetector 162, and a detection signal thus obtained and a signal generated in the clock source 163 are inputted into the phase synchronization controller 164, and a signal for compensating for frequency/phase fluctuation is generated, and is inputted into standard light reproduction light source as a feedback signal. In this way, reproduced standard light having the same frequency accuracy as the frequency standard light can be generated. The reproduced standard light having the same frequency accuracy as the frequency standard light is reflected by the half mirror 165 and outputted to the outside.

On the other hand, as shown in FIG. 3(b), the standard light reproducing unit 16a, b in the system 2 includes a standard light reproduction light source 161 which sends reproduced standard light serving as reference-target light, a photodetector 162 which detects interference light of reference light and the reference-target light, a clock source 163, a phase synchronization controller 164, half mirrors 165, 166, and mirrors 167, 168. In the system 2, frequency standard light (reference light) transmitted from the fiber length fluctuation compensation unit 15a, b is reflected by the half mirror 165, and is guided to the photodetector 162. On the other hand, reproduced standard light, which is reference-target light, is generated in the standard light reproduction light source 161, is transmitted through the half mirror 166, is reflected by the mirror 167, the half mirror 165, and the mirror 168 in this order, is transmitted through the half mirror 165, and is guided to the photodetector 162. Interference light of this reference light and reference-target light is detected by the photodetector 162, a detection signal thus obtained and a signal generated in the clock source 163 are inputted into the phase synchronization controller 164, a signal for compensating frequency/phase fluctuation is generated, and is inputted into the standard light reproduction light source as a feedback signal. In this way, reproduced standard light having the same frequency accuracy as the frequency standard light can be generated. Part of the reproduced standard light having the same frequency accuracy as the frequency standard light is reflected by the half mirror 166, and is then outputted to the outside, and part of the reproduced standard light is transmitted through the half mirror 166, is reflected by the mirror 167, is transmitted through the half mirror 165, and is transmitted to the transmission source of the frequency standard light as reference-target light.

The difference in configuration between the system 1 and the system 2 in the standard light reproducing unit 16a, b is that reproduced standard light is not inputted into the transmission path fiber 14a in the system 1, but reproduced standard light is inputted into the transmission path fiber in the system 2. Both systems are the same in that interference light of frequency standard light, which is reference light, and reproduced standard light, which is reference-target light, is detected by the photodetector 162, and feedback is conducted based on the detection.

In the case where the fiber length fluctuation compensation unit 15a, b is configured with the system 1 (shown in FIG. 2(a)), the configuration of the standard light reproducing unit 16a, b is the system 1 (shown in FIG. 3(a)), while in the case where the fiber length fluctuation compensation unit 15a, b is configured with the system 2 (shown in FIG. 2(b)), the configuration of the standard light reproducing unit 16a, b is also the system 2 (shown in FIG. 3(b)). The system 1 has a characteristic that since beams of frequency standard light are caused to interfere with each other in the fiber length fluctuation compensation unit 15a, b, a difference in center frequency between reproduced standard light and frequency standard light can be easily set as desired. On the other hand, since reproduced standard light is transmitted as reference-target light of the fiber length fluctuation compensation unit 15a, b, the system 2 has a large power of reference-target light and is suitable for long-distance transmission.

In the highly-accurate frequency transmission technology using the conventional technology having such configurations and characteristics, although frequency fluctuation due to temporal variation of an optical path length of a path through which both reference light and reference-target light propagate is compensated for, there is a problem that temporal variation of an optical path length of the other paths degrades the transmission accuracy of frequency standard light. However, against such a problem, an optical interferometer technology which integrates transmission paths and devices on a single substrate to suppress temporal variation of optical path length has been proposed. Such a new technological proposal has advanced higher accuracy in frequency transmission in the highly-accurate frequency transmission technology (for example, see NPL 6).

As mentioned above, in the highly-accurate frequency transmission technology, highly-accurate transmission of frequency standard light has been achieved by the optical interferometer technology. However, the optical interferometers which have been proposed have a configuration for application to the above-mentioned system 2, and have problems as described below in the case of applying the optical interferometers to the system 1. FIG. 4 is a diagram in a case where an optical interferometer 41 is applied in a transmission path system 40 of the highly-accurate frequency transmission technology employing the system 1. As shown in FIG. 4, the transmission path system 40 has a configuration in which a polarization controller 17a, a standard light reproducing unit 16a, and a fiber length fluctuation compensation unit 15b are connected, and has an optical interferometer 41 in which a series of circuits from input of reference light and reference-target light to output of reproduced standard light having the same frequency accuracy as that of frequency standard light is integrated in the standard light reproducing unit 16a and the fiber length fluctuation compensation unit 15b. In the transmission path system 40 having such a configuration, a transmission path fiber 14c through which frequency standard light having frequency/phase fluctuation compensated for is allowed to propagate is disposed between a partial reflection mirror 21 and the optical interferometer 41, the frequency standard light inputted into the standard light reproducing unit 16a receives frequency/phase fluctuation in the transmission path fiber 14c. However, since the current optical interferometer technology cannot compensate for the frequency/phase fluctuation in the transmission path fiber 14c, there is a problem that frequency standard light having frequency/phase fluctuation remained is inputted into the standard light reproducing unit 16a, and as a result, degrades frequency accuracy.

In addition, in the conventional optical interferometer used in the system 2, since interferometers which have the same configuration and are similar to the Mach-Zehnder interferometer are applied to the fiber length fluctuation compensation unit 15b and the standard light reproducing unit 16a, it has been possible to achieve higher accuracy by setting a difference in optical path length between reference light and reference-target light to a predetermined relation. On the other hand, in the system 1, since the standard light reproducing unit 16a is not an interferometer similar to the Mach-Zehnder interferometer, there is also a problem that it is necessary to set a difference in optical path length between reference light and reference-target light to a predetermined relation with different configurations in the fiber length fluctuation compensation unit 15b and the standard light reproducing unit 16a.

### CITATION LIST

### Patent Literatures

NPL 1: Hidetoshi Katori, “Invention and Development of Optical Lattice Clock”, Applied Physics, vol. 81, 8, pp. 656-662 (2012)
NPL 2: Ichiro Ushijima, et al., “Cryogenic optical lattice clocks,” Nature Photonics, vol. 9, pp. 185-189 (2015)
NPL 3: Olivier Lopez, et al., “Cascaded multiplexed optical link on a telecommunication network for frequency dissemination,” Optics Express, vol. 18, no. 16, pp. 16849-16857 (2010)
NPL 4: Tomoya Akatsuka, et al., “30-km-long optical fiber link at 1397 nm for frequency comparison between distant strontium optical lattice clocks,” Japanese Journal of Applied Physics, vol. 53, 032801 (2014)
NPL 5: Long-Sheng Ma, et al., “Delivering the same optical frequency at two places: accurate cancellation of phase noise introduced by an optical fiber or other time-varying path”, Optics Letters, Vol. 19, No. 21, pp. 1777-1779 (1994)
NPL 6: Tomoya Akatsuka, et al., “Optical frequency distribution using laser repeater stations with planar lightwave circuits”, Optics Express 9186, Vol. 28, No. 7, pp. 9186-9197 (2020)

### SUMMARY OF INVENTION

The present disclosure has been made in view of the above-described problems, and an object of the present disclosure is to provide a frequency standard light transmission device which is capable of transmitting frequency standard light with high accuracy in a transmission system of a highly-accurate frequency transmission technology having a configuration of the system 1 (that is, a system for detecting interference light of beams of frequency standard light in a fiber length fluctuation compensation unit).

To achieve the above object, the present disclosure provides an optical interferometer formed by using a waveguide on a substrate, including a fourth coupler which branches light inputted from a reproduced standard light input port into the number of branches A+1 (A≥1); a partial reflection circuit which reflects part of light inputted from a reference light input/output port and transmits part of the light, one frequency synchronization detection circuit which generates first interference light in which the transmitted light from the partial reflection circuit and part of reproduced standard light branched by the first coupler interfere with each other, and a transmission path length fluctuation detection circuit which generates second interference light in which part of the reproduced standard light outputted from the first coupler and light inputted from a transmission path fiber input/output port interfere with each other.

Since the optical interferometer according to the present disclosure is such that devices having the same functions as a partial reflection mirror are integrated on the same substrate, it becomes possible to transmit frequency standard light with high accuracy even in a transmission system of the system 1. In addition, since the optical interferometer according to the present disclosure uses the waveguide technology, it is possible to provide an optical interferometer having a small fluctuation in optical path length. Moreover, against fluctuation in optical path length which is uniformly applied to an optical interferometer board such as a change in temperature of the environment, it is possible to reduce an influence due to temporal variation in optical path length between reference light and reference-target light and to thus generate highly-accurate frequency standard light by setting optical path lengths of specific paths to a predetermined relation.

### BRIEF DESCRIPTION OF DRAWINGS

FIG. 1 is a diagram conceptually showing a configuration of a transmission system 10 using a highly-accurate frequency transmission technology according to a conventional technology.

FIG. 2 is diagrams conceptually showing structures of a fiber length fluctuation compensation unit 15a, b according to the conventional technology, and (a) and (b) show a case of a system 1 and a case of a system 2, respectively.

FIG. 3 is a diagram conceptually showing structures of a standard light reproducing units 16a, b according to the conventional technology, and (a) and (b) show a case of the system 1 and a case of the system 2, respectively.

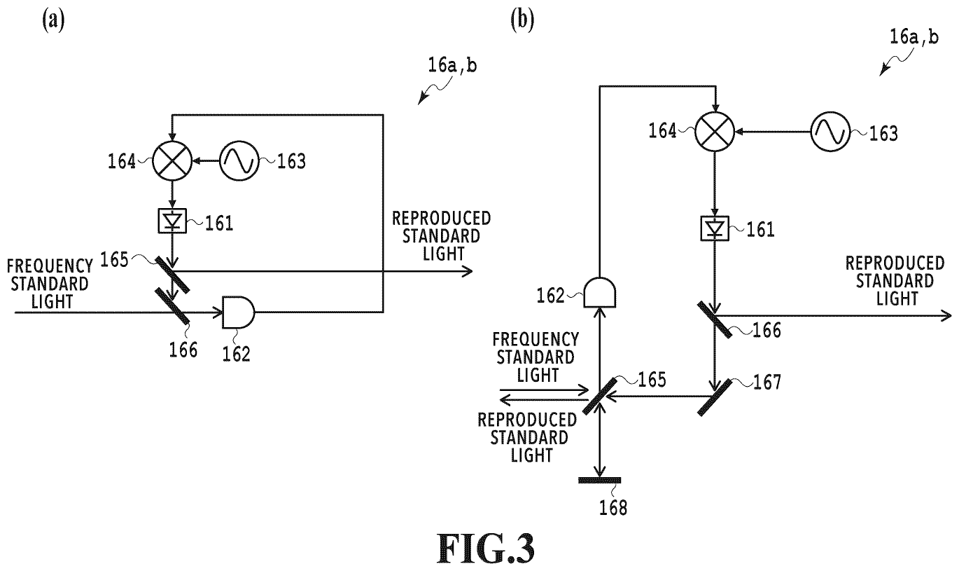

FIG. 4 is a diagram showing a configuration in a case where an optical interferometer 41 is applied in a transmission path system 40 employing a highly-accurate frequency transmission technology of the system 1.

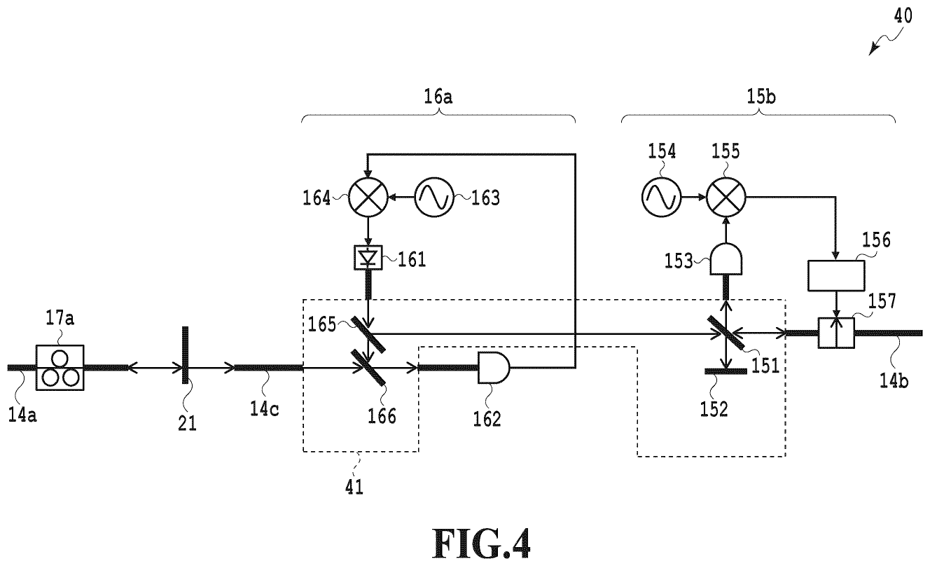

FIG. 5 is a diagram conceptually showing a structure of an optical interferometer 50 according to a first embodiment of the present disclosure.

FIG. 6 is a diagram conceptually showing a structure of an optical interferometer 60 according to a second embodiment of the present disclosure.

### DESCRIPTION OF EMBODIMENTS

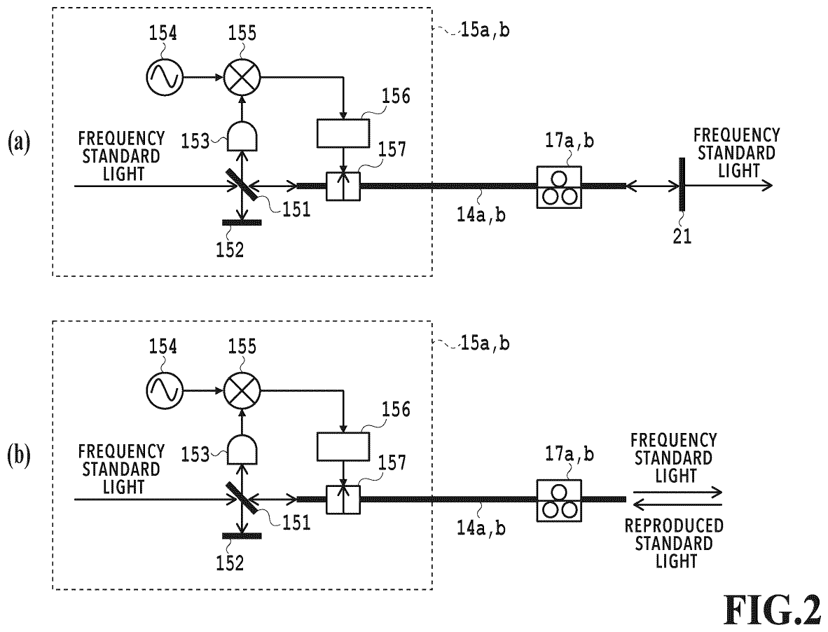

In an optical interferometer according to the present disclosure, a partial reflection mirror (for example, a partial reflection mirror 21 in FIG. 2(a)) in the conventional technology is integrated in the optical interferometer in the form of another device. Moreover, the optical interferometer is designed such that optical path lengths of corresponding paths in the optical interferometer have predetermined relations. This makes it possible to transmit highly-accurate frequency standard light with small influence of temporal variation of optical path lengths even in a transmission system having the configuration of the system 1.

Note that in the present description, the optical interferometer according to the present disclosure is shown as a form using the quartz-based planar lightwave circuit technology. This is because quartz-based planar lightwave circuits are waveguide devices with low loss and high reliability, and have been widely used as platforms for achieving integrated circuits such as optical multiplexers/demultiplexers, optical switches, and optical splitters as optical devices for communication so far. However, this is one example, and the material of the optical interferometer according to the present disclosure is not limited to that of the quartz-based waveguide, but it is also possible to apply waveguide circuits using other materials such as silicon (Si) waveguides, indium phosphide (InP)-based waveguides, and polymer-based waveguides.

### First Embodiment

Hereinafter, a first embodiment of the present disclosure is described in detail with reference to the drawings. The optical interferometer according to the present embodiment relates to a form in which a partial reflection mirror in the conventional technology is disposed as an optical loop mirror in the optical interferometer.

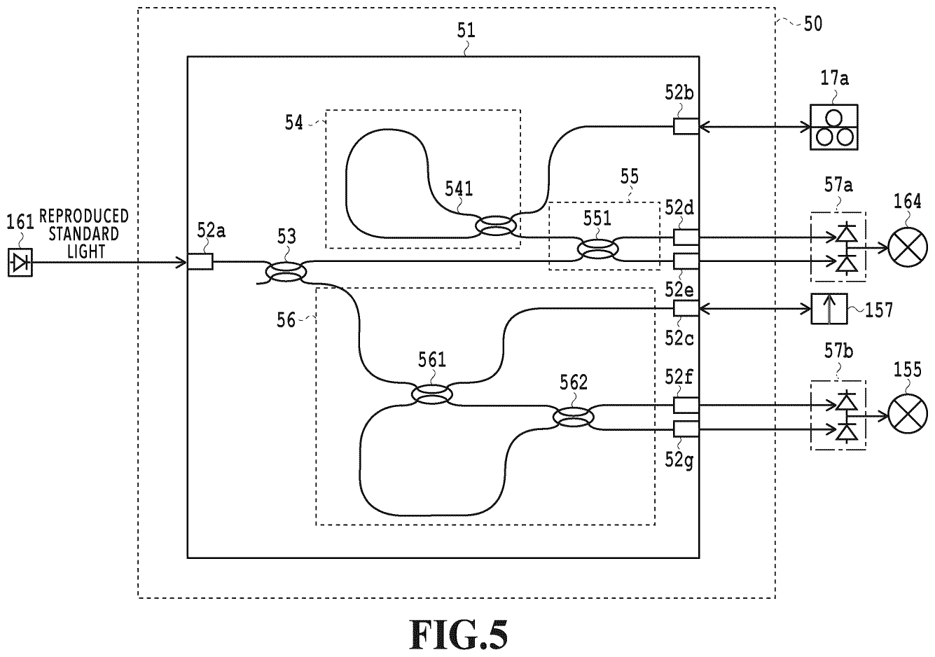

FIG. 5 is a diagram conceptually showing a structure of an optical interferometer 50 according to the first embodiment of the present disclosure. As shown in FIG. 5, the optical interferometer 50 according to the present embodiment is configured with a waveguide circuit formed on a substrate 51, and includes: a reproduced standard light input port 52a, a reference light input/output port 52b; a transmission path fiber input/output port 52c, detected light output ports 52d to g; a first coupler 53 which branches reproduced standard light inputted from the reproduced standard light input port 52a; a partial reflection circuit 54 which functions as a partial reflection mirror in the conventional technology; a frequency synchronization detection circuit 55 which sends interference light of a reference light (frequency standard light) outputted from the partial reflection circuit 54 and a reproduced standard light which is reference-target light branched by the first coupler 53 to a differential light detector 57a disposed outside; and a transmission path length fluctuation detection circuit 56 which sends interference light of reproduced standard light which is reference light branched by the first coupler 53 and reference-target light inputted from the transmission path fiber input/output port 52c to a differential light detector 57b disposed outside. Note that light which propagates in the optical interferometer 50 is an optical signal which propagates in waveguides. This optical signal is inputted and outputted from the reproduced standard light input port 52a, the reference light input/output port 52b, the transmission path fiber input/output port 52c, and the detected light output port 52d to g into the optical interferometer 50, and the ports are connected to devices included in the other highly-accurate frequency transmission technology via optical fibers, respectively (for example, the reproduced standard light input port 52a is connected to a standard light reproduction light source 161).

The first coupler 53 is a coupler which branches inputted reproduced standard light into the number of branches A+1 (A≥1). FIG. 5 shows a form which has A=1 and includes one first coupler 53 as an example, but the number of the first couplers 53 installed may be plural depending on the design. In addition, in order to optimize the power of light outputted from the first coupler 53 to one frequency synchronization detection circuit 55 and A transmission path length fluctuation detection circuits 56, the branching ratio of the first coupler 53 may be set as desired.

The frequency synchronization detection circuit 55 includes one second coupler 551. One input of the second coupler 551 is connected to one output of the first coupler 53, and the other output of the second coupler 551 is connected to one output of the partial reflection circuit 54. The outputs of the second coupler 551 are connected to the detected light output ports 52d and e, and configured such that interference light for detection is guided from the detected light output ports 52d and e to the differential light detector 57a. Such a configuration makes it possible to detect interference light while reducing influences such as fluctuation in power of light and thus improve detection sensitivity of frequency/phase fluctuation as compared with the conventional technology using photodetector (for example, the photodetector 153) for detecting interference light.

The transmission path length fluctuation detection circuit 56 includes one third coupler 561 and one fourth coupler 562. The third coupler 561 is connected to the output of the first coupler 53, the transmission path fiber input/output port 52c, and the fourth coupler 562. The third coupler 561 is then configured to guide part of reproduced standard light branched by the first coupler 53 to the fourth coupler 562 and the other part of the reproduced standard light to the transmission path fiber input/output port 52c, and is configured such that reproduced standard light subjected to frequency/phase fluctuation, which is reference-target light, is inputted from the transmission path fiber input/output port 52c. Note that the third coupler 561 can cause light to propagate from the output to the input due to the reversibility of the optical circuit. In addition, the output of the fourth coupler 562 is connected to the detected light output ports 52f and g, and is configured such that interference light for detection is guided from the detected light output ports 52f and g to the differential light detector 57b.

The partial reflection circuit 54 includes one optical loop mirror 541. The optical loop mirror 541 is a device in which an output of a coupler is connected in a loop shape, and has a function of causing part of light inputted into the optical loop mirror 541 to propagate to the output, and reflecting the remaining light to the input. This reflectance may be set as desired depending on the design. The input of the optical loop mirror 541 is connected to the reference light input/output port 52b, and the output of the optical loop mirror 541 is connected to the frequency synchronization detection circuit 55.

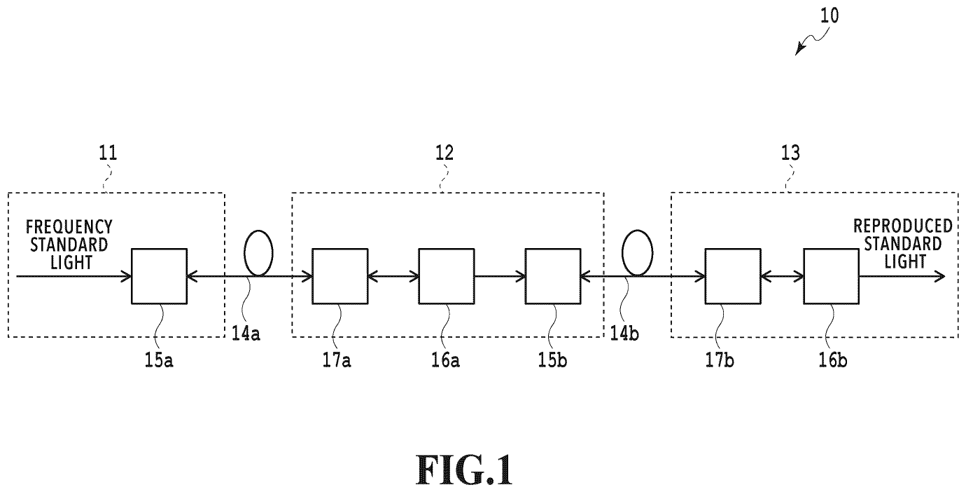

Note that in the example shown in FIG. 1, the frequency synchronization detection circuit 55 in the optical interferometer 50 is described to include one second coupler 551, and generate interference of light transmitted from the partial reflection circuit 54 and light inputted from one output of the first coupler 53. In addition, the frequency synchronization detection circuit 55 is described to be configured to guide the interference light to the differential light detector 57a via the detected light output ports 52d and e. However, these are intended for illustration, and the same effects can be achieved as long as the frequency synchronization detection circuit 55 of the optical interferometer 50 is configured to generate interference light of reference light (frequency standard light) and reference-target light (reproduced standard light) and send the interference light to the outside.

Similarly, the example shown in FIG. 1 shows a form in which the transmission path length fluctuation detection circuit 56 of the optical interferometer 50 includes one third coupler 561 and one fourth coupler 562. However, these are intended for illustration, and the same effects can be achieved as long as the transmission path length fluctuation detection circuit 56 of the optical interferometer 50 is configured to generate interference light of part of the reproduced standard light outputted from the first coupler 53 and light inputted from the transmission path fiber input/output port 52c and send the interference light to the outside.

The flow (optical path) of frequency standard light and reproduced standard light in the optical interferometer 50 according to the present embodiment having such a configuration is described below.

Frequency standard light transmitted from the transmitting station 11 via the transmission path fiber 14a is inputted from the reference light input/output port 52b into the optical interferometer 50, and is guided to the partial reflection circuit 54. In the partial reflection circuit 54, part of the inputted frequency standard light is reflected and outputted from the reference light input/output port 52b, and returns to the fiber length fluctuation compensation unit 15a of the transmitting station 11 via the transmission path fiber 14a as reference-target light. Here, although not shown in FIG. 5, the fiber length fluctuation compensation unit 15a of the transmitting station 11 is configured with an optical system as shown in FIG. 2(a). Then, interference light of frequency standard light as reference light and frequency standard light as reference-target light are detected by the photodetector 153 in the fiber length fluctuation compensation unit 15a of the transmitting station 11, and frequency/phase fluctuation received at the transmission path fiber 14a is compensated for.

On the other hand, frequency standard light which has transmitted through the partial reflection circuit 54 is inputted into the frequency synchronization detection circuit 55. In the frequency synchronization detection circuit 55, interference light of frequency standard light which has transmitted through the partial reflection circuit 54 and reproduced standard light which has been inputted from the reproduced standard light input port and branched by the first coupler 53 is generated. Here, the reference light is frequency standard light which has been inputted from the above-mentioned partial reflection circuit 54 into the frequency synchronization detection circuit 55. On the other hand, the reference-target light is reproduced standard light which has been inputted from the reproduced standard light input port 52a, has passed through the first coupler 53, and has been transmitted to the frequency synchronization detection circuit 55. The interference light of the reference light and the reference-target light is outputted from the detected light output ports 52d and e to the outside, and is inputted into the differential light detector 57a. Then, a detection signal obtained by the detection by the differential light detector 57a and a signal having any frequency Δf₁ outputted from a clock source 163 (not shown) are inputted into the phase synchronization controller 164, and a compensation signal for phase/frequency fluctuation is fed back to the standard light reproduction light source. In this way, reproduced standard light which has the same line width as that of the frequency standard light and has a frequency difference of Δf₁ can be generated from the standard light reproduction light source.

In addition, the reproduced standard light is inputted from the reproduced standard light input port 52a, is branched by the first coupler 53, and is inputted into the transmission path length fluctuation detection circuit 56. In the transmission path length fluctuation detection circuit 56, interference light for compensating for frequency/phase fluctuation received at transmission path fiber 14b to which the transmission destination (for example, a receiving station 13) is connected is generated. Here, the reference light is reproduced standard light which has passed through the third coupler 561 and has been transmitted to the fourth coupler 562. On the other hand, the reference-target light is reproduced standard light which has passed through the third coupler 561, has been reflected by the partial reflection mirror 21 as shown in FIG. 2(a) from the transmission path fiber input/output port 52c via the transmission path fiber 14b, has propagated through the transmission path fiber 14b and inputted from the transmission path fiber input/output port 52c again, has received frequency/phase fluctuation while propagating through the transmission path fiber 14b, and has received frequency shift by the acousto-optic modulator 157. After interference light of the reference light and the reference-target light is generated in the transmission path length fluctuation detection circuit 56, the interference light is outputted from the detected light output ports 52f and g and is inputted into the differential light detector 57b. Then, a detection signal obtained by the detection by the differential light detector 57b and a frequency signal outputted from the clock source 154 (not shown) are inputted into the phase synchronization controller 155, and a compensation signal for frequency/phase fluctuation is generated in the voltage-controlled oscillator and is fed back to the acousto-optic modulator. In this way, light having the same frequency accuracy as that of the reproduced standard light is transmitted to the partial reflection mirror 21, which is the transmission destination.

Based on such a flow of frequency standard light and reproduced standard light (optical path), in the transmission system including the optical interferometer 50, compensation for frequency/phase fluctuation which the frequency standard light received during the transmission and generation of reproduced standard light having the same frequency accuracy as that of the frequency standard light can be achieved.

Subsequently, a length design in an optical circuit for transmitting frequency standard light with high accuracy is described below, focusing on frequency fluctuation in the case where a temporal variation of an optical path length due to vibration, temperature change, and the like is uniform in an interferometer board.

In order to transmit frequency standard light with high accuracy, it is necessary to make frequency accuracies of frequency standard light and reproduced standard light coincide, and to transmit the reproduced standard light to a transmission destination without impairing the accuracy of the reproduced standard light. In the optical interferometer 50, in an optical path through which only reference light or reference-target light propagates, since there is no mechanism for compensating for frequency fluctuation, it is necessary to appropriately set an optical path length.

First, the relation of frequency between frequency standard light and reproduced standard light in the frequency synchronization detection circuit 55 is described. The frequency standard light is compensated for frequency fluctuation received at the transmission path in the fiber length fluctuation compensation unit 15a of the transmission source, and is inputted into the partial reflection circuit 54. In the case where the frequency of the frequency standard light is represented by f₀, the position at which the frequency fluctuation is compensated for is the midpoint of the loop portion of the optical loop mirror 541. Hence, the optical path in which the frequency standard light receives frequency fluctuation is an optical path from the midpoint of the loop portion of the optical loop mirror 541 to the second coupler 551 of the frequency synchronization detection circuit 55, and the optical path length of this optical path is represented by a₁. In addition, the frequency of the reproduced standard light generated in the standard light reproduction light source 161 is represented by f_{RL}. Then, the optical path in which the reproduced standard light receives frequency fluctuation is a sum of an optical path from the standard light reproduction light source 161 to the first coupler 53 via the reproduced standard light input port 52a and an optical path from the first coupler 53 to the second 551 coupler of the frequency synchronization detection circuit 55, and the optical path lengths of these optical paths are represented by b₁ and b₂. In this case, the relation of frequencies between the frequency standard light and the reproduced standard light in the frequency synchronization detection circuit 55 is expressed by (formula 1).

$$[ Math . 1 ]$$

$$( {f}_{R L} + {k}^{′} {b}_{1} + k {b}_{2} ) - ( {f}_{0} + k {a}_{1} ) = Δ {f}_{1} \qquad ( formula 1 )$$

Here, k represents a coefficient of the frequency fluctuation which the standard light receives in the respective optical path of a₁ and b₂ per unit optical path length, and is assumed to be equal in the substrate 51. The optical path of b₁ is an optical path including a fiber outside the substrate, and thus has a different coefficient k′. Δf₁ represents the frequency of the clock source 163, and is feedback-controlled with the frequency f_{RL} of the reproduced standard light to satisfy (formula 1).

Next, the frequency of the reproduced standard light to be sent to the transmission destination is described. The reproduced standard light is transmitted to the transmission destination through the third coupler 561 of the transmission path length fluctuation detection circuit 56. Here, in the case where the optical path length from the first coupler 53 to the third coupler 561 is represented by b₃ and the frequency of the reproduced standard light in the third coupler 561 is represented by f₁, f₁=f_{RL}+k′b₁+kb₃, and thus the frequency is expressed by (formula 2) from (formula 1).

$$[ Math . 2 ]$$

$${f}_{1} = {f}_{0} + Δ {f}_{1} + k ( {a}_{1} - {b}_{2} + {b}_{3} ) \qquad ( formula 2 )$$

That is, in the case where the optical path length is set such that b₃=b₂−a₁ (the difference between the optical path length (b₂) from the first coupler 53 to the second coupler 551 and the optical path length (a₁) from the midpoint of the loop portion of the optical loop mirror 541 to the second coupler 551 becomes equal to the optical path length (b₃) from the first coupler 53 to the third coupler 561), the frequency f₁=f₀+Δf₁ of the reproduced standard light having no frequency fluctuation is achieved in the third coupler 561, so that it is possible to maintain the accuracy without influence even in the case where uniform frequency fluctuation is generated by vibration or temperature change in the optical path in the substrate 51.

Subsequently, the relation of frequency between reference light and reproduced standard light of reference-target light in the transmission path length fluctuation circuit 56 is described. Here, in the case where the optical path length from the third coupler 561 of the transmission path length fluctuation detection circuit 56 to the partial reflection mirror 21 of the transmission destination via transmission path fiber input/output port 52c is represented by c₁, the optical path length of the optical path from one output of the third coupler 561 to one input of the fourth coupler 562 which is an optical path through which the reference light propagates is represented by c₂, the optical path length of the optical path from one output of the third coupler 561 to one input of the fourth coupler 562, that is an optical path through which the reference-target light propagates is represented by c₃, the optical path length in which the reproduced standard light of the reference light receives frequency fluctuation is c₂, and the optical path length in which the reproduced standard light of the reference-target light receives frequency fluctuation is 2c₁+c₃. Since the optical path of c₁ is an optical path including a transmission path fiber, in the case where the coefficient of the frequency fluctuation per unit optical path length is represented by k′ and the frequency shift by the acousto-optic modulator 157 is represented by Δf_{AOM}, the relation of frequency between the reference light and the reference-target light in the fourth coupler 562 is expressed by (formula 3).

$$[ Math . 3 ]$$

$$( {f}_{1} + 2 {k}^{′} {c}_{1} + 2 Δ {f}_{A O M} + k {c}_{3} ) - ( {f}_{1} + k {c}_{2} ) = 2 Δ {f}_{2} \qquad ( formula 3 )$$

Here, 2Δf₂ is the frequency of the clock source 154, and the frequency shift Δf_{AOM} by the acousto-optic modulator 157 is feedback-controlled to satisfy (formula 3).

Here, in the case where the frequency of the reproduced standard light in the partial reflection mirror 21 of the transmission destination is represented by f₂, since f₂=f₁+k′c₁+Δf_{AOM}, f₂ is expressed by (formula 4) from (formula 3).

$$[ Math . 4 ]$$

$$\begin{matrix}{f}_{2} = {f}_{1} + Δ {f}_{2} + k ( {c}_{2} - {c}_{3} ) / 2 \\ = {f}_{0} + Δ {f}_{1} + Δ {f}_{2} + k ( {a}_{1} - {b}_{2} + {b}_{3} ) + k ( {c}_{2} - {c}_{3} ) / 2\end{matrix} \qquad ( formula 4 )$$

That is, in the case where the optical path length is set such that c₂=c₃ (the optical path length (c₂) through which the reference light propagates and the optical path length (c₃) through which the reference-target light propagates become equal to each other), together with the above-described condition b₃=b₂−a₁, the frequency f₂=f₁+Δf₂=f₀+Δf₁+Δf₂ of the reproduced standard light having no frequency fluctuation is achieved in the partial reflection mirror 21 of the transmission destination, so that it is possible to maintain the accuracy without influence even in the case where uniform frequency fluctuation is generated by vibration or temperature change in the optical path in the substrate 51. Note that as a more general condition, a₁−b₂+b₃+ (c₂−c₃)/2=0 only has to be satisfied from (formula 4), the design may be made depending on deviation ΔL of the optical path length like b₃=b₂−a₁+ΔL, c₂=c₃−2ΔL, for example.

Supplementarily, since the frequencies Δf₁ and Δf₂ of the clock sources 163 and 154 are lower by around 6 digits than the frequency f₀ of the frequency standard light, the frequency standard light can be guaranteed to have a frequency accuracy of 18 digits if there is a frequency accuracy of 12 digits as the clock source. In addition, the relation of frequency between the frequency standard light and the reproduced standard light can be reversed in (formula 1), and also the relation of frequency between the reference light and the reference-target light can be reversed by setting the frequency shift by acousto-optic modulator 157 to negative in (formula 3) as well. Hence, the signs of Δf₁ and Δf₂ can be reversed to be eliminated in (formula 4). Although such an optical frequency transmission technology which does not depend on the frequency accuracy of a clock source has already been employed in the system 2, but can also be applied to the system 1.

### EXAMPLE

The optical interferometer 50 was actually fabricated by using the quartz-based planar lightwave circuit technology. Here, as various optical couplers, directional couplers each of which couples light by disposing two waveguides close to each other were used.

This actually fabricated optical interferometer 50 was designed by a minimum bending radius of the waveguides of 2 mm, and was fabricated by using a combination of a glass film deposition technique such as a flame hydrolysis deposition (FHD) method and a fine processing technique such as reactive ion etching (RIE). As a result, a compact chip having a chip size of 13×12 mm could be fabricated. This fabricated chip of the optical interferometer 50 was housed in a module case, but a temperature adjustment mechanism was not particularly provided. The number of branches was set to A=2, so that the fabricated optical interferometer 50 was configured to include two transmission path length fluctuation detection circuits 56. In addition, the branching ratio of light to the frequency synchronization detection circuit 55 and the transmission path length fluctuation detection circuit 56 in the first coupler 53 was set to 1:4, and the branching ratio of light to the transmission path fiber input/output port 52c and the fourth coupler 562 in the third coupler 561 was set to 2:1. The insertion loss of the fabricated optical interferometer 50 was about 12.2 dB between the reproduced standard light input port 52a and the detected light output ports 52d and e of the frequency synchronization detection circuit 55, about 8.2 dB between the reproduced standard light input port 52a and the transmission path fiber input/output port 52c of the transmission path length fluctuation detection circuit 56, about 14.3 dB between the reproduced standard light input port 52a and the detected light output ports 52f and g of the transmission path length fluctuation detection circuit 56, and about 8.0 dB between the transmission path fiber input/output port 52c and the detected light output ports 52d and e of the frequency synchronization detection circuit 55. Thus, an excess loss excluding a principle loss associated with branching or the like was 2.2 to 2.5 dB for every path, so that it was confirmed that a low loss can be achieved.

In addition, a virtual repeater station 12 was configured by using the fabricated optical interferometer 50, and the stability of relay of frequency standard light (modified Allan variance) was evaluated. Specifically, an acousto-optic modulator 157 was disposed between the two transmission path length fluctuation detection circuits 56 and the reference light input/output port 52b, and connected by using a polarization-maintaining fiber, so that one transmission path fluctuation detection circuit was deemed as the virtual repeater station. A polarization-maintaining fiber was connected to the reference light input/output port 52b into which frequency standard light was inputted, and an optical system as shown in FIG. 2(a) was built at the end of the polarization-maintaining fiber. The stability was evaluated by using this system, and a value of 1.0×10⁻¹⁸ was obtained for an average time of 1 second. Since the stabilities of frequency of optical clocks currently studied are 10-16 order for an average time of 1 second, a result of stability better than the currently studied optical clocks by 2 digits was obtained.

As mentioned above, it can be said that the transmission system including the optical interferometer 50 according to the present disclosure is capable of transmitting frequency standard light with high accuracy while having the configuration of the system 1 (that is, a system for detecting interference light of beams of frequency standard light in a fiber length fluctuation compensation unit).

### Second Embodiment

Hereinafter, a second embodiment of the present disclosure is described in detail with reference to the drawings. An optical interferometer according to the present embodiment relates to a form in which a partial reflection mirror is disposed as PR (Partial Reflection) coating in the optical interferometer.

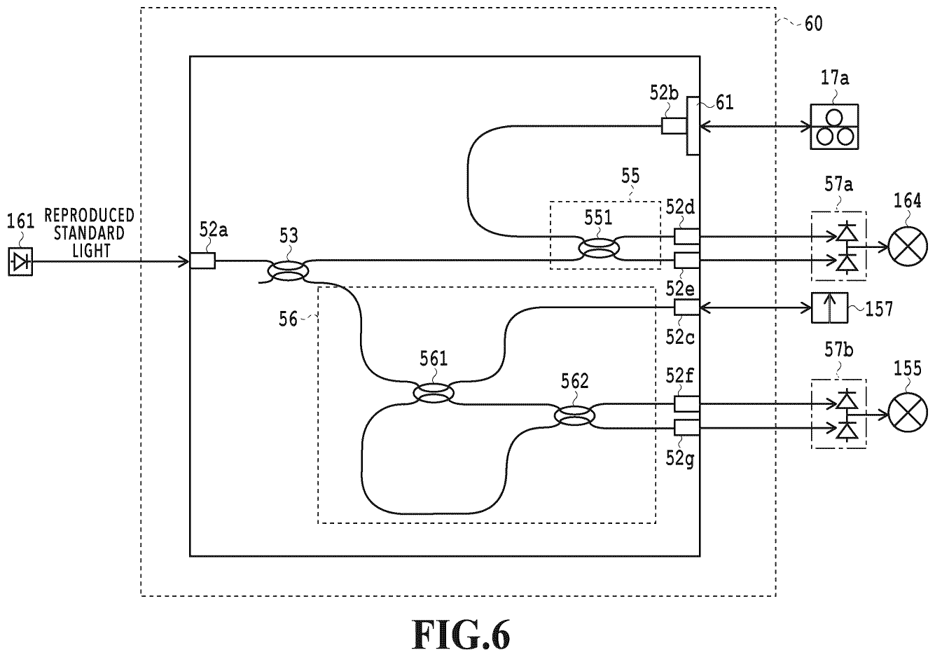

FIG. 6 is a diagram conceptually showing a structure of an optical interferometer 60 according to the second embodiment of the present disclosure. The optical interferometer 60 according to the present embodiment has a form in which the partial reflection circuit 54 is replaced with a partial reflection circuit 61 in the optical interferometer 50 described in the first embodiment. The partial reflection circuit 61 includes PR coating configured with a multi-layer dielectric thin film, and the PR coating can be caused to achieve any reflectance by appropriately designing a thin film depending on a used wavelength band and reflectance. The other circuit configuration is the same as that in the optical interferometer 50.

In the optical interferometer 60 having such a configuration as well, compensation for frequency/phase fluctuation which frequency standard light received during transmission and generation of reproduced standard light having the same frequency accuracy as that of the frequency standard light can be achieved like the optical interferometer 50 described in the first embodiment. The optical interferometer 50 using the optical loop mirror 541 has an advantage that since the optical interferometer 50 can be fabricated in the same process as other optical circuits using waveguides, the fabrication period can be short. On the other hand, the optical interferometer 60 using PR coating allows the used wavelength band to be wider than an optical loop mirror.

In addition, in the case of studying conditions under which frequency accuracies of frequency standard light and reproduced standard light are caused to coincide in a transmission system including the optical interferometer 60, the value of a₁ in the above-mentioned (formula 2) is replaced with an optical path length from an end surface of the PR coating to the second coupler 551.

### INDUSTRIAL APPLICABILITY

As described above, the optical interferometer according to the present disclosure makes it possible to achieve transmission of highly-accurate frequency standard light and suppress frequency fluctuation due to temporal variation of an optical path length in a transmission system of a highly-accurate frequency transmission technology. Moreover, it is possible to improve an influence of a difference in optical path length between reference light and reference-target light and generate highly-accurate frequency standard light by causing an optical path lengths of specific paths in an optical interferometer to have a predetermined relation. Therefore, it is expected that the optical interferometer according to the present disclosure is applied to optical clocks as a frequency standard light transmission technology with high accuracy and high stability.

1. An optical interferometer formed by using a waveguide on a substrate, comprising:
a first coupler that branches light inputted from a reproduced standard light input port into the number of branches A+1 (A≥1);
a partial reflection circuit that reflects part of light inputted from a reference light input/output port and transmits part of the light;
one frequency synchronization detection circuit that generates first interference light that the transmitted light from the partial reflection circuit and part of reproduced standard light branched by the first coupler interfere with each other; and
a transmission path length fluctuation detection circuit that generates second interference light that part of the reproduced standard light outputted from the first coupler and light inputted from a transmission path fiber input/output port interfere with each other.

2. The optical interferometer according to claim 1, wherein
the one frequency synchronization detection circuit
further includes one second coupler,
is connected to an output of the transmitted light from the partial reflection circuit and one output of the first coupler, and
is configured to output the first interference light to an outside via a first detected light output port, and
the transmission path length fluctuation detection circuit
includes:
a third coupler that part of the reproduced standard light outputted from the other output of the first coupler and light inputted from the transmission path fiber input/output port are inputted, and that guides the part of the reproduced standard light inputted from the first coupler to the transmission path fiber input/output port; and
a fourth coupler that is connected to two outputs of the third coupler, and that part of the reproduced standard light and light inputted from the transmission path fiber input/output port are inputted from the one output and the other output, respectively, and
is configured to output the second interference light to the outside via a second detected light output port.

3. The optical interferometer according to claim 2, wherein
an optical path length of an optical path from the third coupler to the fourth coupler, that is an optical path through that part of the reproduced standard light propagates, and an optical path length of an optical path from the third coupler to the fourth coupler, that is an optical path through that light inputted from the transmission path fiber input/output port propagates are equal to each other.

4. The optical interferometer according to claim 2, wherein the partial reflection circuit further includes an optical loop mirror.

5. The optical interferometer according to claim 4, wherein a difference between an optical path length from the first coupler to the second coupler and an optical path length from a midpoint of a loop portion of the optical loop mirror to the second coupler and an optical path length from the first coupler to the third coupler are equal to each other.

6. The optical interferometer according to claim 4, wherein
an optical path length (a₁) from a midpoint of a loop portion of the optical loop mirror to the second coupler,
an optical path length (b₃) from the first coupler to the third coupler,
an optical path length (b₂) from the first coupler to the second coupler,
an optical path length (c₃) of an optical path from the third coupler to the fourth coupler, that is an optical path through that light inputted from the transmission path fiber input/output port propagates, and
an optical path length (c₂) of an optical path from the third coupler to the fourth coupler, that is an optical path through that part of the reproduced standard light propagates are set to satisfy a relation of (formula 1):
$$[ Math . 1 ]$$
$${a}_{1} + {b}_{3} - {b}_{2} = \frac{( {c}_{3} - {c}_{2} )}{2} . \qquad ( formula 1 )$$

7. The optical interferometer according to claim 2, wherein the partial reflection circuit further includes PR coating.

8. The optical interferometer according to claim 7, wherein
a difference between an optical path length from the first coupler to the second coupler and an optical path length from an end surface of the PR coating to the second coupler and an optical path length from the first coupler to the third coupler are equal to each other.

9. The optical interferometer according to claim 8, wherein
the optical path length (a₁) from the end surface of the PR coating to the second coupler,
the optical path length (b₃) from the first coupler to the third coupler,
the optical path length (b₂) from the first coupler to the second coupler,
an optical path length (c₃) of an optical path from the third coupler to the fourth coupler, that is an optical path through that light inputted from the transmission path fiber input/output port propagates, and
an optical path length (c₂) of an optical path from the third coupler to the fourth coupler, that is an optical path through that part of the reproduced standard light propagates are set to satisfy a relation of (formula 2):
$$[ Math . 2 ]$$
$${a}_{1} + {b}_{3} - {b}_{2} = \frac{( {c}_{3} - {c}_{2} )}{2} . \qquad ( formula 2 )$$

10. The optical interferometer according to claim 2, wherein
the first interference light outputted to the outside via the first detected light output port is inputted into a first differential detector, and
the second interference light outputted to the outside via the second detected light output port is inputted into a second differential detector.
